(19) United States
(12) Patent Application Publication
(10) Pub. No.: US 2019/0112835 A1
(43) Pub. Date: Apr. 18, 2019

(54) DIGITAL DOOR LOCK INCLUDING LATCH BOLT SELF-LOOSENING STRUCTURE

(71) Applicant: SAMSUNG SDS CO., LTD., Seoul (KR)

(72) Inventors: Seong-Jong YOO, Seoul (KR); Chul-Ho MAENG, Seoul (KR); Jin JEONG, Seoul (KR)

(73) Assignee: SAMSUNG SDS CO., LTD., Seoul (KR)

(21) Appl. No.: 16/124,894

(22) Filed: Sep. 7, 2018

(30) Foreign Application Priority Data
Oct. 12, 2017 (KR) 10-2017-0132584

(51) Int. Cl. E05B 15/10; E05B 47/00; E05C 3/16

(52) U.S. Cl. CPC E05B 15/10; E05B 2047/0022; E05C 3/167; E05B 47/0012

(57) ABSTRACT

A present invention relates to a digital doorlock including a latch bolt self-loosening structure which includes an authenticator which receives an authentication signal and performs authentication; a motor which is driven in a predetermined direction when authentication is performed by the authenticator; a latch operator which can be operated through driving of the motor; and a shaft which is rotated according to operation of the latch operator and operates a latch bolt, wherein the latch operator releases the latch bolt by operating according to the authentication and rotating the shaft in one direction.

### CROSS-REFERENCE TO RELATED APPLICATION(S)

This application claims the benefit under 35 USC § 119(a) of Korean Patent Application No. 10-2017-0132584, filed on Oct. 12, 2017, in the Korean Intellectual Property Office, the entire disclosure of which is incorporated herein by reference for all purposes.

### BACKGROUND

### 1. Field

The following description relates to a digital door lock, and particularly, to a digital door lock including a latch bolt self-loosening structure capable of unlocking a latch bolt by a rotational force of an electric motor without a connection member for connecting a handle of the door lock and a latch operator.

### 2. Description of Related Art

Generally, a digital door lock includes a mortise installed inside a door and performing a locking function for controlling access through the door and levers installed on each side of the door to control the operation of the mortise.

Conventionally, when a deadbolt is released through authentication using, for example, a password or a registered card, a shaft of a latch operator is rotated through a connection member connecting a handle and the shaft according to a user's operation of the handle and thereby the latch of the mortise is unlocked and the door is opened.

However, in the case of the above structure, the connection member connecting the handle and the shaft may be worn or deformed, thereby increasing looseness of the handle and causing an error in the door lock operation. In addition, there is an inconvenience in that a user's operation, such as turning or pushing/pulling of the handle is necessary to release the latch bolt after the deadbolt is released.

Moreover, there is a problem in that the latch bolt is damaged and worn out due to an attempt to open or close the door in a state in which the handle is not sufficiently turned or pulled to such an extent that the latch can be completed released during the process of turning or pushing/pulling the handle.

### RELATED ART

### Patent Document

Korean Laid-Open Patent Publication No. 10-2011-0058032 (Jun. 1, 2011)

### SUMMARY

This summary is provided to introduce a selection of concepts in a simplified form that are further described below in the Detailed Description. This summary is not intended to is identify key features or essential features of the claimed subject matter, nor is it intended to be used as an aid in determining the scope of the claimed subject matter.

The disclosed embodiments are intended to provide a digital door lock which has little wearing of an internal structure by removing a connection member that connects a door lock handle and a latch operator.

In addition, the disclosed embodiments are intended to provide a digital door lock which is not limited to a shape of the door lock handle, such as a rotary type, a push/pull type, or the like by removing the connection member connecting the handle and the latch operator.

Moreover, the disclosed embodiments are intended to provide a digital door lock in which a deadbolt and a latch bolt can be released by a user's external input and thereby a latch bolt can be released by electric power without a user's action, such as turning or pushing/pulling a handle.

Additionally, the disclosed embodiments are intended to provide a digital door lock capable of preventing an error of a position sensor by operating a motor through double sensing.

Furthermore, the disclosed embodiments are intended to provide a digital door lock in which a latch bolt can be released by electric power without a user's action, such as turning or pushing/pulling of a handle, and thereby a latch bolt can be prevented from being damaged and worn out due to an attempt to open or close a door in a state of insufficient turning or pulling the handle.

In one general aspect, there is provided a digital door lock including: an authenticator which receives an authentication signal and performs authentication; a motor which is driven in a predetermined direction when authentication is performed by the authenticator; a latch operator which can be operated through driving of the motor; and a shaft which is rotated according to operation of the latch operator and operates a latch bolt, wherein the latch operator releases the latch bolt by operating according to the authentication and rotating the shaft in one direction.

The latch operator may include a driving gear rotated through driving of the motor and a rotator which is rotated by the driving gear and rotates the shaft.

The digital door lock may further include a sensor positioned on a side of the rotator and sensing a rotation radius of the rotator, wherein the motor is stopped according to the rotation radius of the rotator.

The rotator may include a first rotator engaged with the driving gear and a second rotator positioned coaxially with the first rotator and rotated by rotation of the first rotator.

The shaft and the first rotator may be integrally formed into one body.

A first sensed portion whose position is sensed by the sensor may be formed on at least a part of one side of one surface of the first rotator toward the sensor and a second sensed portion whose position is sensed by the sensor may be formed on at least a part of the other side of one surface of the second rotator toward the sensor.

The sensor may include at least two position sensors which sense the positions of the first sensed portion and the second sensed portion and the at least two position sensors may be disposed radially about a center axis of the shaft.

Sensing grooves through which the first sensed portion and the second sensed portion can pass may be formed on one side of each of the at least two position sensors and the rotation radius of the rotator may be sensed according to whether the first sensed portion and the second sensed portion pass through the sensing grooves.

The at least two position sensors may include a first sensor, a second sensor, and a third sensor which are formed at an equiangular interval.

When the second sensed portion passes through the first sensor or the second sensor and the first sensed portion passes through the third sensor, the motor may be stopped.

A sensed member whose position is sensed by the sensor may be formed at least a part of one surface of the rotator.

The sensor may include a position sensor which senses the position of the sensed member.

The shaft and the rotator may be integrally formed into one body.

The motor may rotate the shaft in a different direction according to operation of the latch operator after a predetermined length of time elapses from an instance of authentication of the authentication signal.

Other features and aspects will be apparent from the following detailed description, the drawings, and the claims.

### BRIEF DESCRIPTION OF THE DRAWINGS

FIG. 1 is a diagram illustrating an example of a door lock mortise connected to a digital door lock according to one embodiment of the present disclosure.

FIG. 2 is a diagram illustrating a connection between the digital door lock and the door lock mortise according to one embodiment of the present disclosure.

FIG. 3 is an exploded perspective view of a latch operator, a sensor, and a shaft according to one embodiment of the present invention.

FIGS. 4A and 4B are diagrams illustrating a motor and the latch operator according to one embodiment of the present disclosure.

FIG. 5 is a diagram illustrating a latch bolt self-loosening structure according to one embodiment of the present disclosure.

FIG. 6 is a diagram illustrating driving of a latch bolt self-loosening structure for releasing a latch bolt when authentication is performed by an authenticator according to one embodiment of the present disclosure.

FIG. 7 is a diagram illustrating an operation of a latch bolt self-loosening structure for locking a latch bolt according to one embodiment of the present disclosure.

FIG. 8 is a diagram illustrating a latch bolt self-loosening structure according to another embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context.

The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

First, throughout the specification, authentication performed by an authenticator is authentication for driving a deadbolt 30 and a latch bolt 10. The authentication is performed for operating a dead driver and a motor 200 and does not include a user's action, such as turning of a rotary-type handle or pushing/pulling of a push/pull-type handle, which is performed in a prior art to release a latch bolt 10, but include a short-range communication, such as keypad password input, card key input, near-field communication (NFC), Bluetooth, ZigBee, Wi-Fi, etc., and a remote wireless communication, such as long-term evolution (LTE), 4^{TH} generation (4G), 5G, etc.

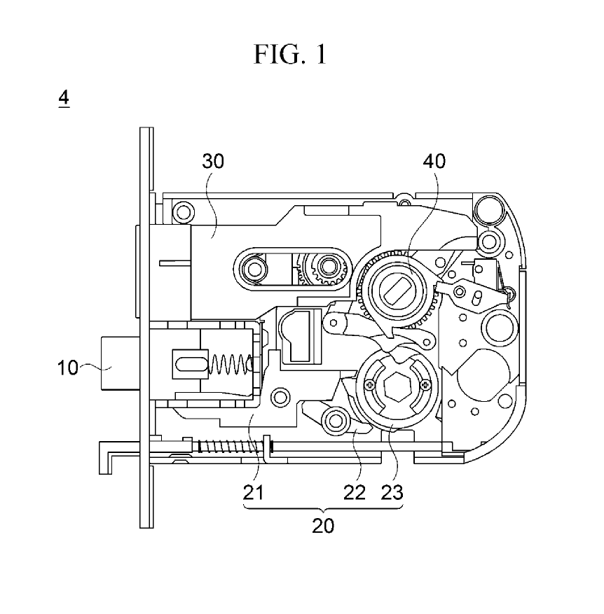

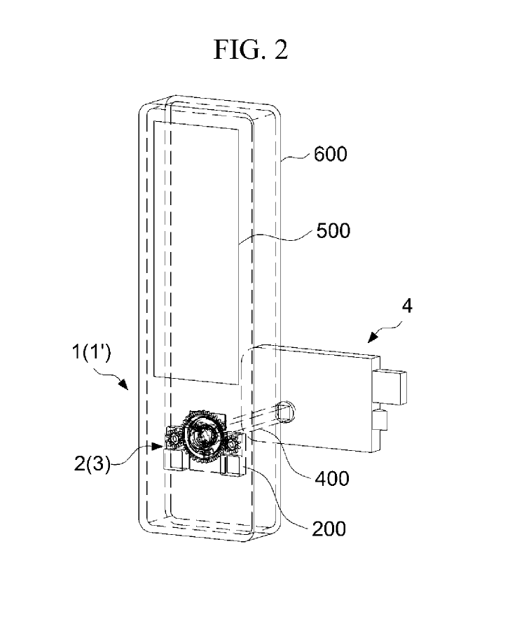

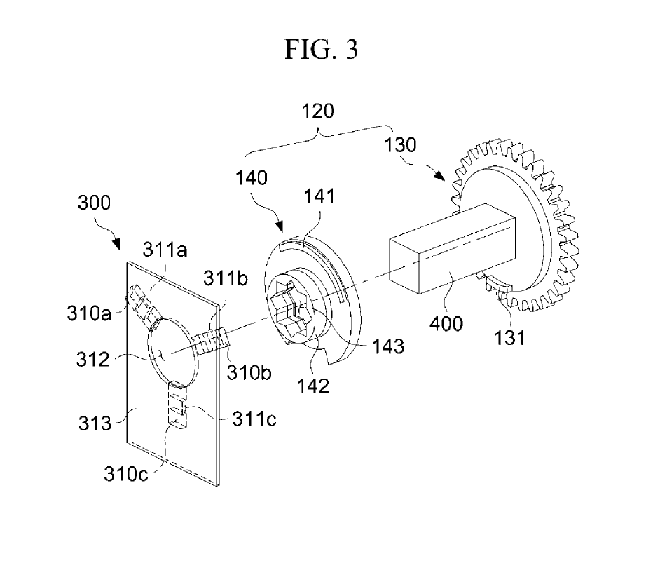

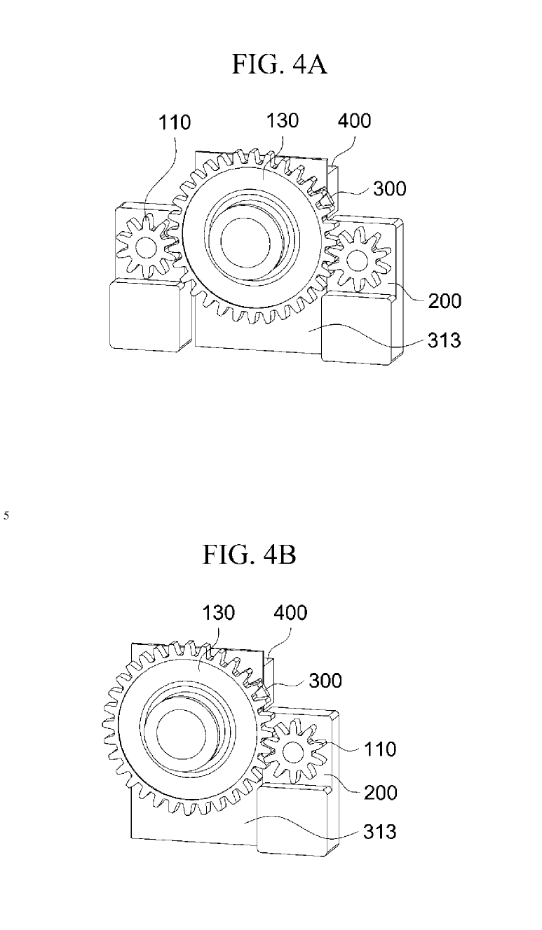

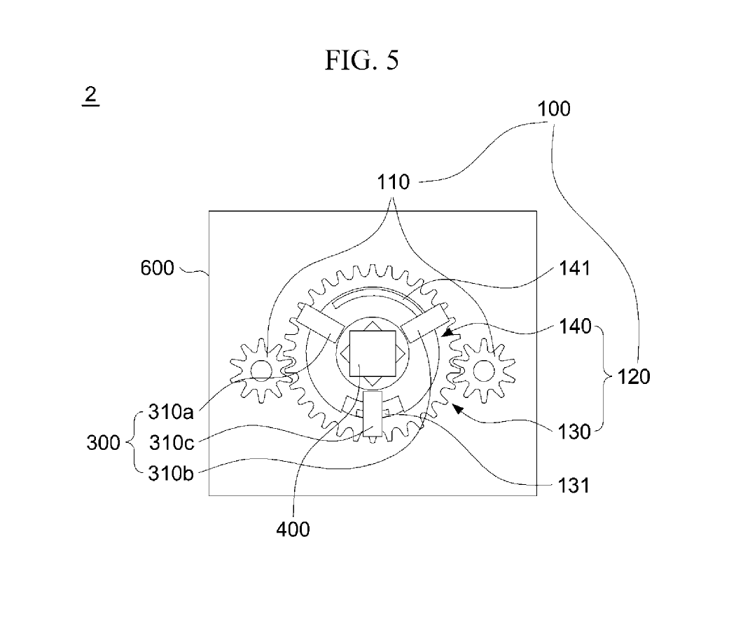

FIG. 1 is a diagram illustrating an example of a door lock mortise 4 connected to a digital door lock 1 according to one embodiment of the present disclosure, FIG. 2 is a diagram illustrating a connection between the digital door lock 1 and the door lock mortise 4 according to one embodiment of the present disclosure, FIG. 3 is an exploded perspective view of a latch operator 100, a sensor 300, and a shaft 400 according to one embodiment of the present invention, FIGS. 4A and 4B are diagrams illustrating a motor 200 and the latch operator 100 according to one embodiment of the present disclosure, and FIG. 5 is a diagram illustrating a latch bolt self-loosening structure 2 according to one embodiment of the present disclosure.

Referring to FIGS. 1 to 5, the digital door lock 1 including the latch bolt self-loosening structure 2 in accordance with one embodiment of the present disclosure may include an authenticator 500 which receives an authentication signal and performs authentication, the motor 200 which is driven in a predetermined direction when the authentication is performed by the authenticator, the latch operator 100 which can be operated through driving of the motor 200, and the shaft 400 which rotates according to operation of the latch operator 100 and operates the latch bolt. In this case, the latch operator 100 may operate according to the authentication and may release the latch bolt 10 as the shaft 400 is rotated in one direction.

As such, according to the authentication, not only the deadbolt 30 but also the latch bolt 10 can be automatically loosened, so that a user can open and close a door without an additional operation for releasing the latch bolt 10, such as rotating or pushing/pulling of a handle.

Specifically, the latch operator 100 may include a driving gear 110 rotated according to driving of the motor 200 and a rotator 120 which is rotated by the driving gear 110 and rotates the shaft 400.

In this case, the motor 200 may be driven by the authentication and rotates the driving gear 110 to rotate the rotator 120 in one direction, or may be stopped according to a rotation radius of the rotator 120. Operations of the motor 200 and the latch operator 100 will be described below.

Meanwhile, the latch bolt self-loosening structure 2 according to one embodiment of the present disclosure may be embedded in a housing 600 at the exterior of the door and can be protected from external foreign materials.

More specifically, the rotator 120 may include a first rotator 130 having gear teeth engaged with the driving gear 110 of the motor 200 and a second rotator 140 disposed coaxially with the first rotator 130 and rotated along with the rotation of the first rotator 130.

In this case, the first rotator 130 and the second rotation 140 may be coupled to each other to rotate together, and the shaft 400 may also rotate together by a through groove 143 of the second rotator 140, which will be described below.

The through groove 143 into which the shaft 400 can be inserted may be formed at the center of the second rotator 140. In this case, a cross-section of the shaft 400 may be formed in an angular shape, such as a rectangle, and a cross-section of the through groove 143 of the second rotator 140 may be formed in an angular shape so that the shaft 400 can penetrate thereinto and can be constrained to rotate together with the second rotator 140. Accordingly, the shaft 400 may rotate along with the rotation of the first rotator 130 and the second rotator 140.

The cross-sections and shapes of the shaft 400 and the through groove 143 illustrated in FIG. 3 are merely example but the embodiment is limited thereto, such that any cross-sections and shapes are sufficient as long as the shaft 400 can rotate together along with the rotation of the second rotator 140.

Further, it is described in the specification that the first rotator 130, the second rotator 140, and the shaft 400 are formed separately and rotate along with each other, but aspects of the present disclosure are not limited thereto. However, it will be apparent to those skilled in that art that the first rotator 130 and the shaft 400 may be integrally formed into one body and rotate along with the second rotator 140 or the first rotator 130, the second rotator 140, and the shaft 400 are integrally formed into one body and be rotated as the motor 200 is driven.

Although it is described in the specification that the first rotator 130, the second rotator 140, and the shaft 400 rotate together with each other, aspects of the present disclosure are not limited thereto and it will be apparent to those skilled in the art that a difference in rotation speed may occur between the first rotator 130 and the shaft 400 by a method in which a difference in gear ratio between the first rotator 130 and the second rotator 140 is applied to cause rotation speeds of the first rotator 130 and the second rotator 140 to be different from each other.

The digital door lock 1 according to one embodiment of the present disclosure may further include the sensor 300 positioned on a side of the rotator 120 to sense a rotation radius of the rotator 120, and the motor 200 may be stopped according to the rotation radius of the rotator 120, which is sensed by the sensor 300.

In addition, the first rotator 130 may include a first sensed portion 131 which is formed to protrude toward the sensor 300 from at least a part of one side of one surface of the first rotator 130 and whose position is sensed by the sensor 300, and the second rotator 140 may include a second sensed portion 141 which is formed to protrude toward the sensor 300 from at least a part of the other side of a surface of the second rotator 140 and whose position is sensed by the sensor 400. A detailed method of stopping the motor 200 will be described below.

In addition, the sensor 300 may include three position sensors 310 which sense the positions of the first sensed portion 131 and the second sensed portion 141, and the three positions sensors 310 may be disposed radially about the center axis of a through-hole 312. In addition, the three position sensors 310 may be formed on a sensing plate 313 on which the through-hole 312 is formed, and as the sensing plate 310 is fixed to the housing 600, the position sensors 310 may be fixed without being rotated even when the first rotator 130 and the second rotator 140 rotate.

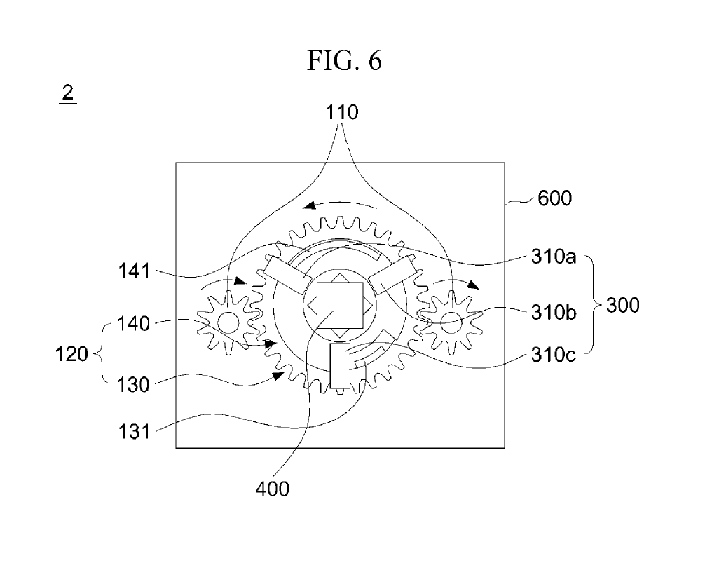

Although the sensing plate 313 is not illustrated in FIGS. 5 and 6, but aspects of the present disclosure are not limited thereto, such that the sensor 300 may include the sensing plate 313 as illustrated in FIGS. 3 and 4.

The three position sensors 310 may be formed at an equiangular interval of about 120 degrees, but aspects of the present disclosure are not limited thereto.

In addition, a sensing groove 311 through which the first sensed portion 131 and a second sensed portion 141 can pass may be formed on one side of each of the three position sensors 310 and the rotation radius of the rotator 120 may be sensed according to whether the first sensed portion 131 and the second sensed portion 141 pass through the sensing groove 311. A detailed method in which the position sensor 310 senses the positions of the first sensed portion 131 and the second sensed portion 141 will be described below.

The sensor 300 may include the circular through-hole 312 formed at the center of the sensor 300, the above-described through groove 143 may be formed at the center of the second rotator 140, and a protrusion 142 which can be inserted into and removed from the through-hole 312 of the sensor 300. In this case, a cross-section of an outer circumference of the protrusion 142 may be formed in a circular shape corresponding to a cross-section of the through-hole 312 and thereby the sensor 300 and the second rotator 140 may be coupled independently of each other so that the sensor 300 does not rotate even when the second rotator 140 is rotated by the first rotator 130.

By doing so, the sensor 300 is not rotated but is fixed whereas the first rotator 130 and the second rotator 140 rotate together. Accordingly, the sensor 300 may sense positions of the first sensed portion 131 and the second sensed portion 141 according to the rotation of the first rotator 130 and the second rotator 140, which will be described below.

In addition, as shown in FIG. 3, the center of the through-hole 312 formed on the sensor 300, the center of the protrusion 142 of the second rotator 140, the center of the first rotator 130, and the center of the shaft 400 may be positioned in alignment with one another and share a virtual center axis by coupling the sensor 300, the first rotator 130, and the second rotator 140 to each other.

Meanwhile, when an external input of a user is received, the dead operator 40 is driven by the dead driver so that the dead the deadbolt 30 may be unlocked. Specifically, when authentication, such as password input, is performed through the above-described authenticator, the dead driver is driven and the dead operator 40 connected to the dead driver is rotated so that the deadbolt 30 can be unlocked.

In addition, the latch bolt 10 is fixed and locked in a state of protruding to an outside of the door lock mortise 4 or is released from fixation and unlocked by a latch locking portion 20 connected to the shaft 400 according to the driving of the motor 200. Specifically, the latch locking portion 20 in the door lock mortise 4 may include a first latch connection member 21, a second latch connection member 22, and a rotation member 23. In this case, the above-described shaft 400 may be inserted into the rotation member 23 and the rotation member 23 may rotate together according to the rotation of the shaft 400.

More specifically, when the first rotator 130 and the second rotator 140 are rotated by the motor 200, the rotation member 23 in the door lock mortise 4 rotates together with the first and the second rotator 130 and 140 through the shaft 400 and the latch bolt 10 may be unlocked according to the rotation of the first latch connection member 21 and the second latch connection member 22, which are connected to the rotation member 23. However, the door lock mortise 4 illustrated in FIG. 1 is an example for describing the embodiments of the present disclosure, and aspects of the present disclosure are not limited thereto.

Meanwhile, in FIG. 4A, two motors 200 are illustrated, which are, however, merely an example, and aspects of the present disclosure are not limited thereto, such that one motor 200 may be provided as shown in FIG. 4A or three or more motors may be provided.

In addition, the driving gear 110 of the present disclosure is merely an example for driving the rotator 120 by the motor 200 and aspects of the present invention is not limited to the driving gear 110 in the drawings, such that any gear, such as a worm gear, a spur gear, rack-pinion gear, or the like, is sufficient as long as it can rotate the rotator 120 according to the driving of the motor 200.

FIG. 6 is a diagram illustrating driving of a latch bolt self-loosening structure 2 for releasing a latch bolt when authentication is performed by an authenticator according to one is embodiment of the present disclosure.

Referring to FIGS. 5 and 6, in a usual locked state of a door lock, each configuration of a digital door lock 1 including the latch bolt self-loosening structure 2 according to one embodiment of the present disclosure may be positioned as shown in FIG. 5. Specifically, the second sensed portion 141 of the second rotator 140 may be positioned in a state of being inserted into a sensing groove 311b of a second sensor 310b on the right of a first sensor 310a in an upper part of the sensor 300 and the first sensed portion 131 of the first rotator 130 may be positioned in a state of being inserted into a sensing groove 311c of a third sensor 310c.

When the door lock is unlocked by the aforementioned authentication, the latch operator 100 is rotated in one direction as shown in FIG. 6 and the latch bolt 10 may be automatically unlocked. More specifically, when authentication, such as a password or a card key, is performed through the authenticator for releasing the door lock, the driving gear 110 of the motor 200 is rotated clockwise, the first rotator 130 engaged with the driving gear 110 is rotated counterclockwise, and the shaft 400 is rotated together with the second rotator 140 through the first rotator 130 so that the latch bolt 10 can be unlocked. Specific configurations and examples of the latch locking portion 20, the shaft 400, and the like involving the unlocking of the latch bolt 10 are described above, and hence detailed descriptions thereof will not be reiterated.

Simultaneously with unlocking of the latch bolt 10, the second sensed portion 141 deviates from the sensing groove 311b of the second sensor 310b in the upper part of the sensor 300 and passes through the sensing groove 311a of the first sensor 310a and the first sensed portion 131 deviates from the sensing groove 311c of the third sensor 310c in the lower part of the sensor 300. As described above, when each of the first sensor 310a and the third sensor 310c recognize that each of the second sensed portion 141 and the first sensed portion 131 pass therethrough, the motor 200 may be stopped. The motor 200 is stopped after rotating according to a predetermined rotation radius of the first rotator 130 and the second rotator 140 so that an overload of the motor 200 due to an excessive rotation and interference between internal structures for locking the latch bolt 10 can be minimized. In addition, through the double recognition of the first sensor 310a and the third sensor 310c, it is possible to prevent an error caused by the inter-operation of the position sensor 310 of the digital door lock 1 in accordance with one embodiment of the present disclosure.

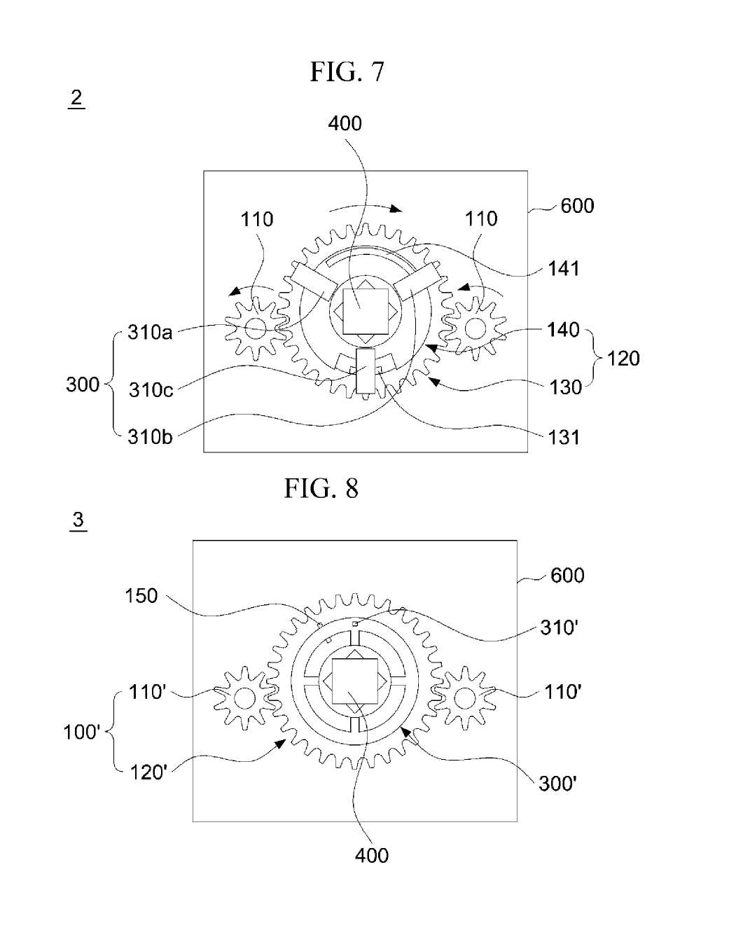

FIG. 7 is a diagram illustrating an operation of a latch bolt self-loosening structure 2 for locking a latch bolt according to one embodiment of the present disclosure.

Referring to FIG. 7, first, a motor 200 of a digital door lock 1 according to one embodiment of the present disclosure may rotate the shaft 400 in a different direction through an operation of the latch operator 100 after a predetermined length of time elapses from the instance of authentication of the above-described authenticator.

For example, when the predetermined length of time is 5 seconds, after 5 seconds elapses from the instant of authentication for unlocking the door lock, the driving gear 110 may rotate counterclockwise in the drawing, and correspondingly, the first rotator 130, the second rotator 140, and the shaft 400 may rotate clockwise. At this time, the latch bolt 10 may be fixed in a state of protruding to the outside of the door lock mortise 4 and return to a locked state by the latch locking portion 20 connected to the shaft 400.

In addition, according to the clockwise rotation of the first rotator 130 and the second rotator 140, the second sensed portion 141 deviates from the sensing groove 311a of the first sensor 310a and is inserted into the sensing groove 311b of the second sensor 310a and at the same time the first sensed portion 131 is inserted into the sensing groove 311c of the third sensor 310c. As such, when each of the second sensor 310b and the third sensor 310c recognize that each of the second sensed portion 141 and the first sensed portion 131 pass therethrough, the motor 200 is stopped and as the motor 200 is stopped after rotating according to the predetermined rotation radius of the first rotator 130 and the second rotator 140, an overload of the motor due to an excessive rotation and interference between internal structures for locking the latch bolt 10 can be minimized. In addition, through the double recognition of the first sensor 310a and the third sensor 310c, it is possible to prevent an error caused by the inter-operation of the position sensor 310 of the digital door lock 1 in accordance with one embodiment of the present disclosure.

Although, in the present specification, it is described that the three position sensors 310 of the sensor 300 in accordance with one embodiment of the present disclosure are radially disposed to recognize the positions of the first sensed portion 131 and the second sensed portion 141, aspects of the present disclosure are not limited thereto. It will be apparent to those skilled in the art that a plurality of position sensors 310, for example four or five position sensors 310, can be disposed to sense the rotation radius of the latch operator 100 as long as an error caused by position sensing can be prevented through two or more position sensors 310.

FIG. 8 is a diagram illustrating a latch bolt self-loosening structure 3 according to another embodiment of the present invention.

Referring to FIG. 8, a digital door lock 1′ including the latch bolt self-loosening structure 3 according to another embodiment of the present disclosure may include an authenticator 500 which receives an authentication signal and performs authentication, a motor 200 which is driven when authentication is performed by the authenticator, a latch operator 100′ which can be operated through driving of the motor 200, and a shaft 400 which rotates according to operation of the latch operator 100′ and operates a latch bolt 10.

In this case, the latch operator 100′ may include a driving gear 110′ rotated according to driving of the motor 200 and a rotator 120′ which is rotated by the driving gear 110′ and rotates the shaft 400.

In addition, a sensor 300′ positioned on a side portion of the rotator 120′ to sense a rotation radius of the rotator 120′ may be further included.

Further, the latch operator 100′, the motor 200, and the sensor 300′ may be embedded in a housing 600 and can be protected from external foreign materials. Moreover, the motor 200 may rotate the rotator 120′ in one direction upon authentication of an authenticator 500 and may be stopped according to a rotation radius of the latch operator 100′.

Specifically, unlike the first rotator 130 and the second rotator 140 according to one embodiment of the present disclosure, the rotator 120′ may be formed as one body and may include a sensed member 150 which is formed on at least a part of one surface of the rotator 120′ toward the sensor 300′ and whose position is sensed by the sensor 300′. The sensor 300′ may include a position sensor 310′ which senses the position of the sensed member 150. The rotator 120′ may rotate corresponding to driving of the motor 200, and at this time, like the latch operator 100 and the sensor 300 according to the preceding embodiment of the present disclosure, the sensor 300′ may be engaged and fixed such that the sensor 300′ is not constrained by the rotation of the latch operator 100′. By doing so, the sensed member 150 may be rotated about the center axis of the latch operator 100′ and pass under the position sensor 310′ and the sensor 300′ may sense the rotation radius of the rotator 120′.

The operation and stopping of the motor 200 and the unlocking of the latch bolt 10 according to the rotation of the shaft 400 are the same as those in the above-described digital door lock 1 according to one embodiment of the present disclosure, and thus detailed descriptions thereof will not be reiterated.

As described above, in the digital door lock 1 and 1′ including the latch bolt self-loosening structure 2 and 3 according to the embodiments of the present disclosure, the deadbolt is released by an external input of a user and the door lock is automatically unlocked as the motor 200 is operated. Accordingly, a user is not required to use a handle for unlocking the door lock, thereby improving user's convenience in using a door lock.

In addition, it is possible to release the latch bolt 10 by electric power without a user's action, such as turning or pushing/pulling of a handle, and thereby it is possible to prevent the latch bolt 10 from being damaged and worn out due to attempts to open or close the door in a state of insufficient turning or pulling of the handle and to reduce the cost incurred by replacement or repair of the latch bolt 10.

Further, since a connection member (not shown) for connecting the handle and a configuration for locking the latch bolt 10 does not exist, there is no a problem of wearing of the conventional connection member connecting a door lock handle and the latch operator 100 or 100′ and any type of handle used for a door lock, such as a rotary-type handle, a push/pull type handle, or the like, can be used, thereby improving efficiency of mass production of door lock products.

According to the embodiments of the present disclosure, there may be little wearing of internal configuration by removing a connection member connecting a door lock handle and a latch operator.

In addition, according to the embodiments of the present disclosure, a shape of the door lock handle may not be limited to a particular handle type, such as a rotary type, a push/pull type, or the like by removing the connection member connecting the handle and the latch operator.

Moreover, according to the embodiments of the present disclosure, since the deadbolt and the latch bolt can be released by an external input of a user, it is possible to release the latch bolt by electric power without a user's action, such as turning or pushing/pulling of a handle.

Additionally, according to the embodiments of the present disclosure, it is possible to prevent an error by a position sensor by operating the motor through double sensing.

Furthermore, according to the embodiments of the present disclosure, since the latch bolt can be released by electric power without a user's action, such as turning or pushing/pulling of a handle, it is possible to prevent the latch bolt from being damaged or worn out due to attempts to open or close the door in a state of insufficient turning or pulling of the handle.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### REFERENCE NUMERALS

1, 1′: DIGITAL DOOR LOCK

2, 3: LATCH BOLT SELF-LOOSENING STRUCTURE

4: DOOR LOCK MORTISE

10: LATCH BOLT

20: LATCH LOCKING PORTION

21: FIRST LATCH CONNECTION MEMBER

22: SECOND LATCH CONNECTION MEMBER

23: ROTATION MEMBER

30: DEADBOLT

40: DEAD OPERATOR

100, 100′: LATCH OPERATOR

110, 110′: DRIVING GEAR

120, 120′: ROTATOR

130: FIRST ROTATOR

131: FIRST SENSED PORTION

140: SECOND ROTATOR

141: SECOND SENSED PORTION

142: PROTRUSION

143: THROUGH GROOVE

150: SENSED MEMBER

200: MOTOR

300, 300′: POSITION SENSOR

310A: FIRST SENSOR

310B: SECOND SENSOR

310C: THIRD SENSOR

311, 311A, 311B, 311C: SENSING GROOVE

312: THROUGH-HOLE

313: SENSING PLATE

400: SHAFT

500: AUTHENTICATOR

600: HOUSING

What is claimed is:

1. A digital door lock comprising:
an authenticator which receives an authentication signal and performs authentication;
a motor which is driven in a predetermined direction when authentication is performed by the authenticator;
a latch operator which can be operated through driving of the motor; and
a shaft which is rotated according to operation of the latch operator and operates a latch bolt,
wherein the latch operator releases the latch bolt by operating according to the authentication and rotating the shaft in one direction.

2. The digital door lock of claim 1, wherein the latch operator includes a driving gear rotated through driving of the motor and a rotator which is rotated by the driving gear and rotates the shaft.

3. The digital door lock of claim 2, further comprising a sensor positioned on a side of the rotator and sensing a rotation radius of the rotator,
wherein the motor is stopped according to the rotation radius of the rotator.

4. The digital door lock of claim 3, wherein the rotator includes a first rotator engaged with the driving gear and a second rotator positioned coaxially with the first rotator and rotated by rotation of the first rotator.

5. The digital door lock of claim 4, wherein the shaft and the first rotator are integrally formed into one body.

6. The digital door lock of claim 4, wherein a first sensed portion whose position is sensed by the sensor is formed on at least a part of one side of one surface of the first rotator toward the sensor and a second sensed portion whose position is sensed by the sensor is formed on at least a part of the other side of one surface of the second rotator toward the sensor.

7. The digital door lock of claim 6, wherein the sensor includes at least two position sensors which sense the positions of the first sensed portion and the second sensed portion and the at least two position sensors are disposed radially about a center axis of the shaft.

8. The digital door lock of claim 7, wherein sensing grooves through which the first sensed portion and the second sensed portion can pass are formed on one side of each of the at least two position sensors and the rotation radius of the rotator is sensed according to whether the first sensed portion and the second sensed portion pass through the sensing grooves.

9. The digital door lock of claim 8, wherein the at least two position sensors include a first sensor, a second sensor, and a third sensor which are formed at an equiangular interval.

10. The digital door lock of claim 9, wherein when the second sensed portion passes through the first sensor or the second sensor and the first sensed portion passes through the third sensor, the motor is stopped.

11. The digital door lock of claim 3, wherein a sensed member whose position is sensed by the sensor is formed at least a part of one surface of the rotator.

12. The digital door lock of claim 11, wherein the sensor includes a position sensor which senses the position of the sensed member.

13. The digital door lock of claim 11, wherein the shaft and the rotator are integrally formed into one body.

14. The digital door lock of claim 1, wherein the motor rotates the shaft in a different direction according to operation of the latch operator after a predetermined length of time elapses from an instance of authentication of the authentication signal.
